(19) United States
(12) Patent Application Publication
(10) Pub. No.: US 2003/0001129 A1
(43) Pub. Date: Jan. 2, 2003

(54) Dye colored fire fighting foam concentrate

(76) Inventors: Mitchell James Hubert, Menominee, MI (US); Stephen Aloysius Barker, Menominee, MI (US); David Nelson Valley, Peshtigo, WI (US)

Correspondence Address: BANNER & WITCOFF, LTD., 28 STATE STREET, 28th FLOOR, BOSTON, MA, 02109, US

(21) Appl. No.: 09/883,705

(22) Filed: Jun. 18, 2001

(51) Int. Cl. A62D 1/00

(52) U.S. Cl. 252/3

(57) ABSTRACT

A fire fighting foam concentrate containing a foamable fire fighting agent, a water-soluble dye, and glycol ether. A fire fighting foam concentrate containing a fluorosurfactant-based fire fighting agent and a water-soluble dye. The concentrates are usually diluted with up to 100 times (v/v) water and aerated into a foam. In addition, a method for evaluating fire fighting foam concentrate concentrations in the fire fighting foam compositions created when the concentrates are diluted.

### BACKGROUND

The present invention relates generally to compositions and methods for evaluating fire fighting foam concentrates. In the use of fire fighting foams, it is common practice to buy and store these fire fighting agents in concentrated form. These concentrates are then mixed with water in the proper mix or proportioning ratio, typically 1:99, 3:97, or 6:94 concentrate-to-water as a volume/volume ratio. Mixing is typically accomplished with hardware developed specifically for this purpose. It is important to obtain the proper mix ratio in order for the foam that is made from this concentrate and water mixture to be effective in combating fires. The National Fire Protection Association (NFPA) requires that the mix ratio be controlled in a narrow acceptable range; for fire fighting applications other than fire trucks, this range currently is from 1 to 1.3 times the stated use percentage but not more than one percentage point above the manufacturer's stated use percentage. For example, for a 1% concentration, the acceptable mix ratio would be from 1.0% to 1.3%. In like manner, a 3% concentrate would need to be mixed in a ratio of from 3.0% to 3.9%, and a 6% concentrate would need to be mixed in a ratio from 6.0% to 7.0%. Fire trucks may typically have a slightly different range, but are controlled within defined limits. Traditional methods of measuring this mix or proportioning ratio have included measurement of refractive index and, more recently, electrical conductivity of the solution.

None of the methods presently available to determine the mix ratio of the fire fighting foam composition are sufficiently expedient, accurate, or inexpensive in actual use. Further, there is no method for evaluating such compositions once they have been foamed and dispensed.

It is an object of the present invention to address one or more of the above-mentioned problems. It is a further object of one or more preferred embodiments of the present invention to provide an accurate method of measuring the mix ratio of fire fighting foam concentrates mixed with diluent, especially when the diluent is sea water or water with a high electrolyte or dissolved solids content. It is a still further object of one or more preferred embodiments of the present invention to provide a method for evaluating the mix ratio after the fire fighting foam composition has been foamed.

### SUMMARY OF INVENTION

The present invention relates to a fire fighting concentrate, which when diluted to prepare a fire fighting composition, contains a concentration of water-soluble dye proportionate to the concentration of the fire fighting concentrate in the fire fighting composition. The use of water-soluble dyes in this manner allows for expedient, accurate, and inexpensive determination of the fire fighting concentrate mix ratio.

In accordance with a first aspect, a fire fighting foam concentrate comprises foamable fire fighting agent, water-soluble dye, and glycol ether, each in known relative concentrations. In accordance with certain preferred embodiments, further discussed below, the fire fighting foam concentrate comprises fluorosurfactant-based foamable fire fighting agent, water-soluble dye, and diethylene glycol butyl ether.

In accordance with another aspect, a fire fighting foam concentrate comprises fluorosurfactant-based foamable fire fighting agent and water-soluble dye in known relative concentrations. In accordance with certain preferred embodiments, further discussed below, the fire fighting foam concentrate comprises fluorosurfactant-based foamable fire fighting agent and water soluble dye. The fire fighting foam concentrate may further comprise glycol ether, hydrocarbon-based foamable fire-fighting agent, water-soluble polymer, and/or inorganic salts.

In accordance with another aspect, a fire fighting composition comprises fire fighting foam concentrate as disclosed above, together with suitable diluent, preferably an aqueous diluent, such as water, e.g. sea water, or the like.

In accordance with a method aspect, a method of fighting a fire comprises applying a fire fighting composition as disclosed above.

In accordance with another method aspect, a method is provided for evaluating a fire fighting composition as disclosed above. The method comprises:

a) introducing into a suitable diluent, preferably an aqueous liquid, a fire fighting foam concentrate as disclosed above, to obtain a resultant mixture, a spectral property of the resultant mixture, preferably dye color intensity, being proportional to the concentration of fire fighting agent in the resultant mixture;

b) obtaining a sample of the resultant mixture; and

c) comparing the spectral property of the sample to a pre-established standard.

In accordance with certain preferred embodiments of this method aspect, the fire fighting composition is foamed and the foam is allowed to relax back to its liquid form prior to comparing the spectral property of the sample to a pre-established standard.

Additional aspects, features, and advantages of the fire fighting foam materials and methods disclosed here will be apparent from the following detailed description of certain preferred embodiments.

### DETAILED DESCRIPTION

From the foregoing disclosure, it will be understood by those skilled in the art that fire fighting foam materials disclosed here can be prepared in accordance with known techniques. In accordance with certain preferred embodiments, a water-soluble dye, preferably a glycol ether, and any of various other optional ingredients are added to a foamable fire fighting agent such that the dye and the foamable fire fighting agent are in known relative concentrations. Water soluble dye, as used herein, means a dye that is substantially soluble in water or a dye that is dispersible in water. Optionally, the resulting fire fighting foam concentrate further comprises diluent, preferably water or other aqueous liquid, to achieve a suitable concentrate. The fire fighting foam concentrate can be foamed and used immediately or stored as the concentrate on-site for use as needed. In using the fire fighting foam concentrate, diluent, preferably an aqueous diluent such as water, e.g. sea water, is added to form a fire fighting composition capable of being aerated into a foam effective in combating fires. The mix or proportioning ratio of the fire fighting foam concentrate to diluent, and, therefore, correspondingly, the ratio of foamable fire fighting agent to diluent in the foam, can be evaluated or determined. Specifically, a spectral property of the resultant mixture, e.g. dye color intensity or absorbance or transmittance of radiant energy, e.g. light, is compared with a pre-established standard. The fire fighting foam composition can be sampled for this comparison either before being aerated into a foam or subsequent to being foamed, after the foam has relaxed back into liquid form.

A fire fighting foam concentrate in accordance with this disclosure can be manufactured using a foamable fire fighting agent, a water-soluble dye, and preferably a glycol ether. The foamable fire fighting agent may be diluted in accordance with this specification or as would be understood or known by those skilled in the art, to produce a stable foam upon aeration or other foaming technique known to those skilled in the art. The foam may then be sprayed or applied over or into a fire to extinguish the fire, such as by depriving it of oxygen. In certain preferred embodiments, the foamable fire fighting agent comprises fluorosurfactant-based agent. In other preferred embodiments, the foamable fire fighting agent comprises both fluorosurfactant-based and hydrocarbon surfactant-based agent. In still other preferred embodiments, the fire fighting foam concentrate may be formulated to produce an alcohol-resistant fire fighting composition. Such embodiments preferably comprise, together with the foamable fire fighting agent and any other suitable ingredients, a water-soluble polymer that is substantially insoluble in other polar solvents, e.g. alcohols. In other preferred embodiments, the fire fighting foam concentrate further includes inorganic salts.

Exemplary foamable fire fighting agents include one or more alkyl-fluorosurfactants such as Lodyne S-103A, Lodyne K81'84, and Lodyne F-102R as manufactured by Ciba Specialty Chemicals (High Point, N.C.); Forafac 1157N as manufactured by AtoFina Chemicals (Philadelphia, Pa.); and DX3001 as supplied by Dynax Corporation (Elmsford, N.Y.). Use level of the fluorosurfactant-based foamable fire fighting agent depends on the intended nominal proportioning ratio. For a 6% concentrate the use level typically would be from 1 to 10 wt. %; for a 3% concentrate the use level typically would be from 2 to 15 wt. %; and for a 1% concentrate the use level typically would be from 2 to 20 wt. %. Exemplary hydrocarbon surfactants include alkyl sulfates having carbon chain lengths of C8 to C14 commercially available from Rhodia Chemicals (Cranbury, N.J.) or Stepan Company (Northfield, Ill.); alkyl ether sulfates with 2 to 4 moles of ethoxylation having carbon chain lengths of C8 to C14 commercially available from Stepan Company or Witco (Houston, Tex.); alkyl betaines having carbon chain lengths of C8 to C14 commercially available from Rhodia Chemicals or Lonza Specialty Chemicals (Fair Lawn, N.J.); alkyl iminodipropionates having carbon chain lengths of C10 to C14 commercially available from Rhodia Chemicals or Henkel Corp. (Cincinnati, Ohio); and ethoxylated octyl phenol having 2 to 4 moles of ethoxylation commercially available from Rhodia Chemicals. Again, use level of the hydrocarbon surfactant-based foamable fire fighting agent depends on the intended nominal proportioning ratio. For a 6% concentrate the use level of one or more of these surfactants typically would be from 1 to 10 wt. %; for a 3% concentrate the use level of one or more of these surfactants typically would be from 1 to 15 wt. %; and for a 1% concentrate the use level of one or more of these surfactants typically would be from 2 to 20 wt %. Exemplary water-soluble polymers for alcohol-resistant fire fighting foam concentrate include guar gum, locust bean gum, alignates, gum Arabic, xanthan gum, or other biogums. Other suitable foamable fighting agents and water-soluble polymers will be apparent to one skilled in the art in light of this disclosure.

Numerous suitable water-soluble dyes for use in the fire fighting foam materials disclosed here are commercially available or can be prepared in accordance with known methods, and will be apparent to those skilled in the art, given the benefit of this disclosure. The water-soluble dye is preferably stable at a pH range of 7.0 to 8.5. The water-soluble dye should demonstrate a spectral property in the fire fighting composition, at least in the composition's liquid form, that is, either before foaming or after a foamed sample is allowed to relax back to its liquid state. Spectral property, as used herein, refers to dye color intensity or absorbance or transmittance of radiant energy, e.g. light. The spectral property preferably has a measurable value directly proportional to the concentration of the dye over a suitable range. Exemplary water-soluble dyes include Benzoate Methyl Violet Lake commercially available from Paul Ulich & Co. (Hastings on Hudson, N.Y.), Green Shade #19162 commercially available from Tricon Colors, Inc. (Elmwood Park, N.J.), Diarylide Yellow commercially available from Sun Chemicals (Cincinnati, Ohio), or Phthalo Blue Lake G commercially available from Chemetron Corp. (Holland, Mich.). In certain preferred embodiments, dye level concentration may be from 0.0001 to 2 wt. %. Other appropriate dyes will be apparent to those skilled in the art in light of this disclosure.

In certain preferred embodiments, glycol ether may be added to the concentrate. The glycol ether may advantageously serve as a foam enhancer in the fire fighting composition, may add to the total dissolved solids content of the concentrate, and may depress the freezing point of the concentrate. The use level of glycol ether in certain preferred embodiments may range from 5 to 20 wt. %. Numerous suitable glycol ethers for use in the fire fighting foam materials disclosed here are commercially available or can be prepared in accordance with known methods, and will be apparent to those skilled in the art, given the benefit of this disclosure. Exemplary glycol ethers include diethylene butyl monoglycol ether, butyl cellosolve, and propylene oxide-based glycol ether.

In certain preferred embodiments, the fire fighting foam concentrate includes an inorganic salt. The inorganic salts may increase the ionic strength of the concentrate as well as increase the total dissolved solids content of the concentrate, and may also aid in film formation in soft water systems. Exemplary inorganic salts include magnesium sulfate heptahydrate and urea. Other appropriate salts will be apparent to those skilled in the art in light of this disclosure. Other additives, e.g. lubricants, surfactants, viscosity modifiers, corrosion inhibitors, emulsifiers, or dispersants, are optionally included. Such additives are commercially available or can be prepared in accordance with known methods, and their use will be apparent to those skilled in the art, given the benefit of this disclosure.

In accordance with certain preferred embodiments, fire fighting foam concentrates are prepared by mixing water-soluble dye, glycol ether, and foamable fire fighting agent with diluent, preferably aqueous diluent or other suitable solvent. The dye is preferably dissolved in diethylene glycol butyl ether. The concentration of the dye in the final composition will be proportionate to the concentration of the concentrate in the composition. This mixture is then mixed, along with foamable fire fighting agent and preferably water.

### EXAMPLE

An exemplary fire fighting foam concentrate in accordance with the present disclosure is detailed in the table below, along with a fire fighting composition formed from such concentrate. More particularly, Table A shows preferred ranges for each of the ingredients in such exemplary concentrate and the corresponding ranges in the foam composition prepared by foaming the concentrate with diluent.

TABLE A

| | Wt. % in Fire Fighting | Wt. % in Fire Fighting |
|---|---|---|
| | Foam Concentrate | Composition |
| Alkyl-Fluorosurfactant | 1-20 | 0.02-0.6 |
| Hydrocarbon Surfactant | 1-20 | 0.02-0.6 |
| Water-Soluble Dye | 0.0001-2 | 0.000001-0.12 |
| Glycol Ether | 5-20 | 0.5-3.48 |
| Water-Soluble Polymer | 0-2.0 | 0-0.12 |
| Water | 38-93 | 2.31-9.3 |
| Diluent | 0 | 94-99 |

Table B shows two exemplary fire fighting foam concentrates. Example 1 is a fire fighting concentrate designed for use on hydrocarbon fuels, e.g. gasoline, kerosene, jet fuel, and naphtha. The concentrate was mixed 3:97 (v/v) with tap water and expanded into foam using an air-aspirating nozzle. The foam fulfilled all fire test requirements set forth in Underwriters Laboratories (UL), Standard for Safety UL 162 Foam Equipment and Liquid Concentrates (7th ed. Mar. 30, 1994), using heptane as a fuel. Example 2 is an alcohol resistant fire fighting concentrate designed for use on polar fuels, e.g. alcohol. The concentrate was mixed 6:94 (v/v) with tap water and expanded into foam using an air-aspirating nozzle. The foam fulfilled all fire test requirements set forth in Underwriters Laboratories (UL), Standard for Safety UL 162 Foam Equipment and Liquid Concentrates (7th ed. Mar. 30, 1994), using isopropyl alcohol as a fuel.

TABLE B

| | Example 1 | Example 2 |
|---|---|---|
| | wt. % in Fire | wt. % in Fire |
| | Fighting Foam | Fighting Foam |
| | Concentrate | Concentrate |
| Lodyne F-102R | 6.0 | 6.0 |
| (fluorosurfactant) | | |
| Forafac 1157N | 0 | 2.0 |
| (fluorosurfactant) | | |
| Sodium Octyl Sulfate | 2.0 | 2.0 |
| (hydrocarbon surfactant) | | |
| Lauryl iminodipropionate | 5.0 | 5.0 |
| (hydrocarbon surfactant) | | |
| Diethylene Glycol | 12.0 | 12.0 |
| Monobutyl Ether | | |
| (glycol ether) | | |
| Ethoxylated Octyl Phenol | 0.5 | 0.5 |
| (hydrocarbon surfactant) | | |
| Benzoate Methyl Violet | 0.004 | 0.005 |
| Lake | | |
| (water-soluble dye) | | |
| Xantham Gum | 0 | 1.1 |
| (water-soluble polymer) | | |
| Tap Water | 74.496 | 71.395 |
| (diluent) | | |

The concentrate is typically stored for long periods of time, for example up to twenty-five years when stored in air-tight containers at room temperature. At the site of a fire, the fire fighting foam concentrate is measured into a fixed amount of diluent and mixed into a fire fighting composition, after which it is aerated into a foam, which is applied to the fire to extinguish the fire. The mixing of the fire fighting foam concentrate and diluent can alternately take place elsewhere, with the fire fighting composition then transferred to the site of the fire for aeration into a foam and application to the fire. Alternately, the fire fighting foam concentrate is injected into a flowing stream of diluent at a predetermined ratio and the stream is subsequently aerated into a foam and applied to the fire. Appropriate means of mixing, foaming, and applying the fire fighting composition to a fire by automated or manual means or combinations thereof are known to those skilled in the art and will be apparent given this disclosure. The diluent is preferably an aqueous solution, and can range from pure water to a solution that contains a high level of electrolyte and/or dissolved solid content, for example, sea water. Other suitable diluents will be apparent to those skilled in the art in light of this disclosure.

Advantageously, the presence of the water-soluble dye in preferred embodiments of the fire fighting foam concentrates disclosed here provides an expedient, accurate, and inexpensive method to evaluate the level of fire fighting foam concentrate in the fire fighting composition. Typically, a spectral property of the fire fighting composition will be linearly or substantially linearly proportional to the concentration of dye in the fire fighting composition over at least a certain concentration range of the dye in the fire fighting composition. Accordingly, the amount of dye in the fire fighting foam concentrate preferably is controlled to within a preselected concentration range, such that the spectral property of the fire fighting composition will be within such linear range when the fire fighting concentrate is mixed in proper proportion with diluent to form the fire fighting composition. The spectral property by which the concentration of fire fighting foam concentrate in the fire fighting composition is evaluated can be dye color intensity, that is, the color intensity established by the water-soluble dye or by the dye together with other color-contributing components of the composition. Suitable methods may also include the measurement of absorbance or transmittance of one or more predetermined wavelengths of light, either by visual observation and comparison to pre-made standards or by instrument measurement, or other methods that will be apparent to those skilled in the art given this disclosure. For example, the fire fighting composition can be evaluated by color comparators to pre-made standards. The spectral measurement provides an indication of the actual concentration of fire fighting foam concentrate in the fire fighting composition. Alternatively, the measurement may be used as an indication of the amount of fire fighting foam concentrate relative to the desired amount, that is, an indication of whether the concentration is too high or too low.

In certain preferred embodiments, the concentration can be determined through spectrometry by comparing the absorbance or transmittance of radiant energy with that of a standard or set of standards of known concentration. A sample of the fire fighting composition is collected, optionally foamed and allowed to relax, and the absorbance or transmittance of the fire fighting composition is compared to that of a preestablished standard or preestablished set of standards. From the ratio of absorbances or transmittances of the standard and the sample and the known concentration of dye in the standard, the concentration of dye in the sample can be determined, and from that, the concentration of fire fighting foam concentrate in the fire fighting composition can be determined. Exemplary spectrometers include the Spectronic 20 or the Minispec 20, commercially available from Bausch and Lomb. After allowing the instrument to warm up for a suitable period of time, the wavelength of the spectrometer is set to an appropriate analytical wavelength for the particular water-soluble dye contained in the sample. Such analytical wavelength will typically be supplied by the manufacturer, or alternatively can be empirically determined, e.g. by collecting an absorbance or transmittance spectrum of the sample. An appropriate analytical wavelength will typically be the wavelength of maximum absorbance or transmittance. Preferably, the water-soluble dye will exhibit a primary analytical wavelength and suitable secondary analytical wavelengths. Such secondary analytical wavelengths would be chosen if there is some interference at the primary analytical wavelength, for example absorbance at that wavelength by the blank. Suitable means and methods for determining appropriate analytical wavelengths will be apparent to those skilled in the art given the benefit of this disclosure.

As noted above, suitable spectrometers for use in the methods disclosed here include the Spectronic 20 commercially available from Bausch and Lomb. Exemplary use of a Spectronic 20 device is now described. After allowing the instrument to warm up for a suitable period of time, and having set the wavelength of the spectrometer to the desired analytical wavelength, the mode of the Spectronic 20 is set to transmittance, and with no tube in the sample chamber, the transmittance is set to 0% with the zero control knob. A blank is then placed into a sample tube. The blank preferably comprises diluent used to dilute the concentrate. The sample tube containing the blank is placed in the sample chamber of the Spectronic 20, and the transmittance is set to 100% using the transmittance control knob. The mode can at this point be optionally changed to absorbance. The sample is placed in a sample tube and inserted into the sample chamber, and the transmittance or absorbance is read and recorded. Finally, a preestablished standard is placed in a sample tube, inserted into the sample chamber, and the transmittance or absorbance of the standard is read and recorded. The standard preferably comprises the actual dye-colored concentrate and the same diluent used to prepare the fire fighting composition being analyzed, mixed in known concentrations. In certain preferred embodiments, a set or series of standards is made in this way, each one of the set comprising a different fire fighting concentrate concentration. Taken together, the set or series of standards preferably encompasses the desired concentration of the fire fighting composition. A calibration curve is prepared by plotting the absorbance or transmittance value for each one of the set of standards against its respective concentration of fire fighting foam concentrate. The concentration of fire fighting foam concentrate in the fire fighting composition is then determined by plotting the absorbance or transmittance value of the sample on the calibration curve. The concentration that corresponds with the absorbance of the sample is the concentration of the fire fighting composition. Alternative suitable methods for determining the concentration of concentrate in the fire fighting composition by measurement of a spectral property of the fire fighting composition corresponding to the amount of water-soluble dye will be apparent to those skilled in the art given this disclosure.

The advantages of this method of evaluating the concentration of fire fighting foam concentrate in the fire fighting composition are many. Traditional methods of such an evaluation have been by means of refractive index or by electrical conductivity of the composition, both of which suffer from lack of accuracy, particularly when the diluent is sea water or other water containing a high amount of dissolved solids or electrolytes. Components such as glycol ethers and inorganic salts are added in higher levels to the prior known concentrates to increase the refractive index or total ionic strength or electrical conductivity of the concentrates, providing increased accuracy in measuring concentration. The method here disclosed eliminates such problems. Therefore the concentration of glycol ethers and inorganic salts can be decreased relative to prior known concentrates. In accordance with preferred embodiments of the present invention dye color intensity is used for measuring concentration such that the need for these elevated levels of glycol ether and inorganic salt is removed, thereby reducing the cost of production. The fire fighting composition can be analyzed before it has been foamed and/or after, by permitting the foam to relax back into liquid form and sampling it at that point in time. Other advantages of using a colored dye include, but are not limited to: easy identification by color of a particular type of foam concentrate in fire emergencies; ease in determining that concentrate flow has been established in translucent eductor pick-up tubes. Other advantages will be apparent to those skilled in the use of fire fighting foam equipment and procedures, given this disclosure.

Various illustrative embodiments of the compositions and methods of the invention having been shown and described above by way of example only. It is anticipated that variations to these described compositions and methods will occur to those skilled in the art in light of the present disclosure and that such modifications and changes may be made without departing from the spirit of the invention, or the scope of the appended claims.

We claim:

1. A fire fighting foam concentrate comprising:
foamable fire fighting agent;
water-soluble dye; and
glycol ether.

2. The fire fighting foam concentrate of claim 1 where the foamable fire fighting agent comprises fluorosurfactant-based foamable fire fighting agent.

3. The fire fighting foam concentrate of claim 2 wherein the foamable fire fighting agent is alcohol resistant.

4. The fire fighting foam concentrate of claim 2 where the foamable fire fighting agent is non-alcohol resistant fluorosurfactant-based foamable fire fighting agent.

5. The fire fighting foam concentrate of claim 2 further comprising hydrocarbon based foamable fire fighting agent.

6. The fire fighting foam concentrate of claim 1, comprising:
not more than 40% by weight of the foamable fire fighting agent, based on the weight of the fire fighting foam concentrate;
not more than 2% by weight of the water-soluble dye, based on the weight of the fire fighting foam concentrate; and
not more than 20% by weight of the glycol ether, based on the weight of the fire fighting foam concentrate.

7. The fire fighting foam concentrate of claim 1, comprising:
not less than 1% by weight of the foamable fire fighting agent, based on the weight of the fire fighting foam concentrate;
not less than 0.0001% by weight of the water-soluble dye, based on the weight of the fire fighting foam concentrate; and
not less than 5% by weight of the glycol ether, based on the weight of the fire fighting foam concentrate.

8. A fire fighting foam concentrate comprising:
fluorosurfactant-based foamable fire fighting agent; and
water-soluble dye.

9. The fire fighting foam concentrate of claim 8, further comprising:
hydrocarbon-based foamable fire fighting agent.

10. The fire fighting foam concentrate of claim 8 wherein the fluorosurfactant-based foamable fire fighting agent is alcohol resistant.

11. A fire fighting composition comprising:
foamable fire fighting agent;
water soluble dye;
glycol ether; and
diluent.

12. A method of fighting a fire comprising applying a fire fighting composition comprising:
foamable fire fighting agent;
water soluble dye;
glycol ether; and
diluent.

13. A method of evaluating fire fighting foam, said method comprising:
a) introducing into an aqueous liquid a fire fighting foam concentrate comprising:
foamable fire fighting agent;
glycol ether; and
water soluble dye,
to obtain a resultant mixture, a spectral property of the resultant mixture being proportional to the concentration of fighting agent in the resultant mixture;
b) obtaining a sample of the resultant mixture; and
c) comparing the spectral property of the sample to a preestablished standard.

14. The method of claim 13, further comprising determining the concentration of fire fighting foam concentrate in the resultant mixture.

15. The method of claim 13, wherein the spectral property comprises color intensity.

16. The method of claim 13, wherein the spectral property comprises absorption of light at a particular wavelength.

17. The method of claim 13, further comprising:
d) between steps a and b, foaming the resultant mixture and permitting the foamed resultant mixture to relax back into liquid form.
